(19) United States
(12) Patent Application Publication
(10) Pub. No.: US 2011/0081065 A1
(43) Pub. Date: Apr. 7, 2011

(54) CENTRALIZED IMAGE RECONSTRUCTION FOR TOMOGRAPHIC IMAGING TECHNIQUES IN MEDICAL ENGINEERING

(76) Inventor: Christian CANSTEIN, Erlangen (DE)

(21) Appl. No.: 12/891,948

(22) Filed: Sep. 28, 2010

(30) Foreign Application Priority Data
Oct. 1, 2009 (DE) 10 2009 048 072.2

(51) Int. Cl. G06K 9/00

(52) U.S. Cl. 382/131; 382/128

(57) ABSTRACT

At least one embodiment of the invention relates to a system for reconstructing image data of examination subjects from scan data. In at least one embodiment, the system includes at least a first and a second medical device for capturing scan data of examination subjects, and a computer for reconstructing image data from scan data, the computer being connected to the first and the second medical device. The computer has an input for receiving scan data from the medical devices and an output for transmitting reconstructed image data to the medical devices.

### PRIORITY STATEMENT

The present application hereby claims priority under 35 U.S.C. §119 on German patent application number DE 10 2009 048 072.2 filed Oct. 1, 2009, the entire contents of which are hereby incorporated herein by reference.

### FIELD

At least one embodiment of the invention generally relates to a system for reconstructing image data of examination subjects from scan data.

### BACKGROUND

In tomographic imaging, the examination subject, usually a patient, is first scanned. The medical device used is accordingly also known as a scanner. From the scan data obtained, image data is then reconstructed, the image reconstruction algorithm used depending on the type of scanner. The reconstructed image data consists of two-dimensional image slices through the examination subject; it is also possible to obtain three-dimensional volume images. Frequently used tomographic techniques are computed tomography (CT) and nuclear magnetic resonance (NMR) tomography.

For scanning of an examination subject with a CT system, circular scans, sequential circular scans with patient feed-through or spiral scans are used. During these scans, absorption data of the examination subject is captured from different capture angles using at least one X-ray source and at least one X-ray detector disposed opposite one another and said absorption data or more specifically projections thus collected is processed by a computer into image slices through the examination subject by means of appropriate reconstruction techniques.

A technique known as filtered back projection (FBP) is nowadays used as the standard method of reconstructing CT images from X-ray CT datasets of a computed tomography device (CT scanner), i.e. from the projections acquired. Although in recent years iterative reconstruction techniques have been developed with which at least some of the limitations of FBP can be overcome, such methods are very compute-intensive.

### SUMMARY

In at least one embodiment of the present invention, a system is disclosed for reconstructing image data of examination subjects from scan data. In addition, at least one embodiment a corresponding computer, a method, a computer program and a computer program product are disclosed.

The system according to at least one embodiment of the invention for reconstructing image data of examination subjects from scan data comprises at least a first and a second medical device, the medical devices each being used to capture scan data of examination subjects. Additionally connected to the first and second medical device is a computer which is used to reconstruct image data from scan data. The computer has an input for receiving scan data from the medical devices and an output for transmitting reconstructed image data to the medical devices.

The system has at least three components: the two medical devices and the computer. It is also possible to provide more than two medical devices subject to the control of the computer. Whereas the medical devices are used to capture the data required for calculating an image of the respective examination subject, image calculation is not performed by components of the medical devices. Instead, this task is performed by the computer. The calculation capacity is therefore not distributed in a decentralized manner over the plurality of medical devices, but concentrated in the computer. The computer can be a single computer with sufficient computing power for image reconstruction; alternatively, a cluster comprised of a plurality of computers can also be present.

The type of image reconstruction performed by the computer depends, among other things, on the specifics of the medical devices. Per se known algorithms can be used. It is advantageous for the computer to be of powerful design, as this allows particularly compute-intensive algorithms to be employed.

The computer and the medical devices are separate from one another, i.e. the computer is not a component part of either the first or the second medical device. This does not exclude the possibility of its being part of another medical device. Accordingly, the computer can be e.g. in another room, another building, another town or even in another country or continent than the medical devices. The same also applies from one medical device to the other(s).

The scan data captured by the first and the second medical device are mutually independent. In particular, they can relate to other examination subjects or scanning of the same examination subject in different ways.

In order to receive from the medical devices the scan data on which image calculation is to be based and make the calculated image data available to them, a connection exists between the medical devices and the computer. The medical devices do not need to be interconnected; in this case the medical devices are linked to the computer in a star connection. For data transmission between the computer and the medical devices, various data transmission methods and physical transport paths can be employed. It is particularly advantageous to use the Internet. This allows virtually any geographical distribution of the medical devices, without having to specially provide an infrastructure for connecting them to the computer.

The medical devices or at least some of the medical devices may be installed so remotely from one another that they are located in different time zones. This is advantageous in that the bulk of the scan data reaches the computer at different times, so that its capacity can be efficiently utilized “around the clock”.

The first and the second medical device can be different types of tomographic equipment. Possibilities include all devices for 3-dimensional medical imaging such as, for example, CT, NMR, AX, PET, mammography.

It is particularly advantageous if encryption devices are provided which enable data to be transmitted securely between the medical devices and the computer. Such devices can be disposed in the medical devices and/or in the computer. Protection against interception and falsification of data is particularly important in the medical field.

The computer according to at least one embodiment of the invention is used to reconstruct image data of examination subjects from scan data. It has a connection to at least a first and a second medical device which capture scan data of examination subjects in each case. The computer also has an input for receiving scan data from the medical devices, and an image reconstruction component for reconstructing image data from received scan data. Lastly, an output is present for transmitting reconstructed image data to the medical devices.

In at least one embodiment of the inventive method for reconstructing image data of examination subjects from scan data, a computer receives first and second scan data, said first scan data of a first examination subject having been captured by a first medical device and the second scan data of a second examination subject having been captured by a second medical device. The computer reconstructs first image data of the first examination subject from the first scan data and second image data of the second examination subject from the second scan data. Finally, the computer transmits the first image data to the first medical device and the second image data to the second medical device.

The sequence of steps of this method can vary. For example, the receiving of the scan data from the first medical device, the calculation of the first image data and the transmission of the first image data to the first medical device can take place first, followed by the corresponding steps in respect of the second medical device.

The embodiments and developments described with reference to the system according to the invention are correspondingly also applicable to the computer according to the invention and the method according to the invention.

The computer program according to at least one embodiment of the invention has program code segments suitable for carrying out the method of the type described above when the computer program is run on the computer. The computer program product according to at least one embodiment of the invention comprises program code segments stored on a computer-readable data medium which are suitable for carrying out the method of the type described above when the computer program is run on the computer.

### BRIEF DESCRIPTION OF THE DRAWINGS

The invention will now be explained in greater detail with reference to an example embodiment:

FIG. 1: shows a first schematic representation of an example embodiment of a computed tomography system comprising an image reconstruction component,

FIG. 2: shows a second schematic representation of an example embodiment of a computed tomography system comprising an image reconstruction component,

FIG. 3: shows a plurality of distributed tomography systems with a central image reconstruction computer.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

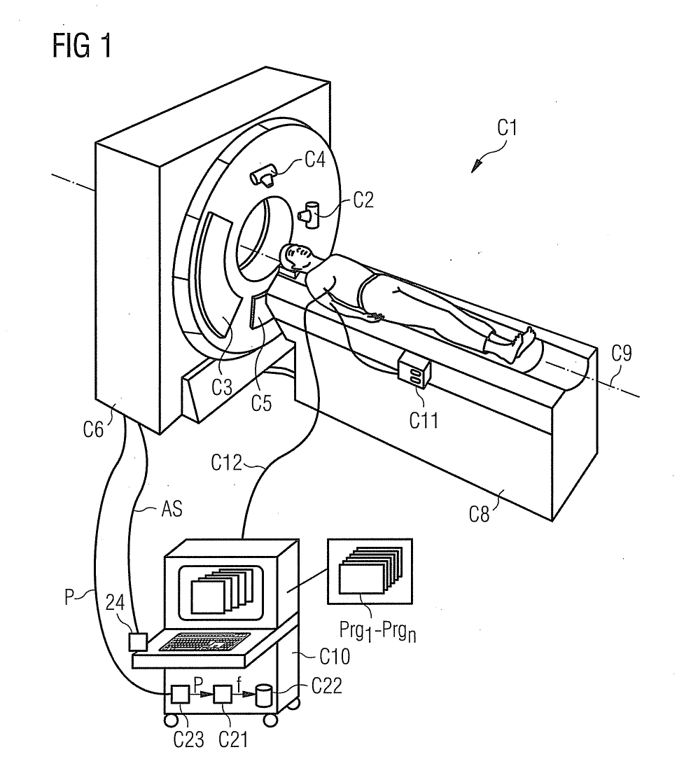

FIG. 1 firstly schematically illustrates a first computed tomography system C1 with an image reconstruction device C21. The gantry housing C6 accommodates a closed gantry (not shown) on which a first X-ray tube C2 and detector C3 are disposed opposite one another. Optionally a second X-ray tube C4 and detector C5 are disposed opposite one another in the CT system shown here so that a higher time resolution can be achieved by the additionally available emitter/detector combination, or to enable also “dual energy” examinations to be carried out when using different X-ray energy spectra in the emitter/detector systems.

The CT system C1 also has a patient table C8 on which a patient can be slid into the scan field of view along a system axis C9, also termed the z-axis, during the examination, the scanning itself also being performable as a pure circular scan exclusively in the region of interest without patient feed-through. Here the X-ray source C2/C4 rotates about the patient, while the detector C3/C5 opposite parallels the movement of the X-ray source C2/C4 in order to capture projection measurement (scan) data which is then used for reconstructing image slices. Alternatively to a sequential scan whereby the patient is moved through the scan field between the individual scans, a spiral scan is self-evidently also possible whereby the patient is moved continuously along the system axis C9 through the scan field between X-ray tube C2/C4 and detector C3/C5 during rotational scanning with the X-ray radiation. Due to the movement of the patient along the axis C9 and the simultaneous rotation of the X-ray source C2/C4, during a spiral scan a helical trajectory is produced for the X-ray source C2/C4 relative to the patient during the measurement. This trajectory can also be achieved by moving the gantry along the axis C9 with the patient remaining stationary.

The CT system 10 is controlled by a control and computing unit C10 using a computer program code Prg₁ to Prgₙ present in a memory. From the control and computing unit C10, acquisition control signals AS can be transmitted via a control interface 24 to control the CT system C1 in accordance with particular scanning protocols.

The projection scan data p (hereinafter also referred to as raw data) acquired by the detector C3 or C5 is passed via a raw data interface C23 to the control and computing unit C10. Said raw data p then undergoes further processing in an image reconstruction component C21, possible after suitable pre-processing. In this example embodiment, the image reconstruction component C21 is realized in the form of software on a processor in the control and computing unit C10, e.g. in the form of one or more of the computer program codes Prg₁ to Prgₙ. The image data f reconstructed by the image reconstruction component C21 is then stored in a memory C22 of the control and computing unit C10 and/or displayed in the usual manner on the monitor of the control and computing unit C10. It can also be fed via an interface not shown in FIG. 1 into a network, e.g. a radiological information system (RIS) connected to the computed tomography system C1, and stored in a mass storage element accessible there, or output as images.

In addition, the control and computing unit C10 can also perform the function of an ECG, a line C12 being used to extract the ECG potentials between patient and control and computing unit C10. In addition, the CT system C1 shown in FIG. 1 also has a contrast agent injector C11 via which contrast agent can be additionally injected into the patient's bloodstream so that the patient's blood vessels, in particular the ventricles of the beating heart, can be better represented. This also offers the possibility of carrying out perfusion measurements for which the proposed method is likewise suitable.

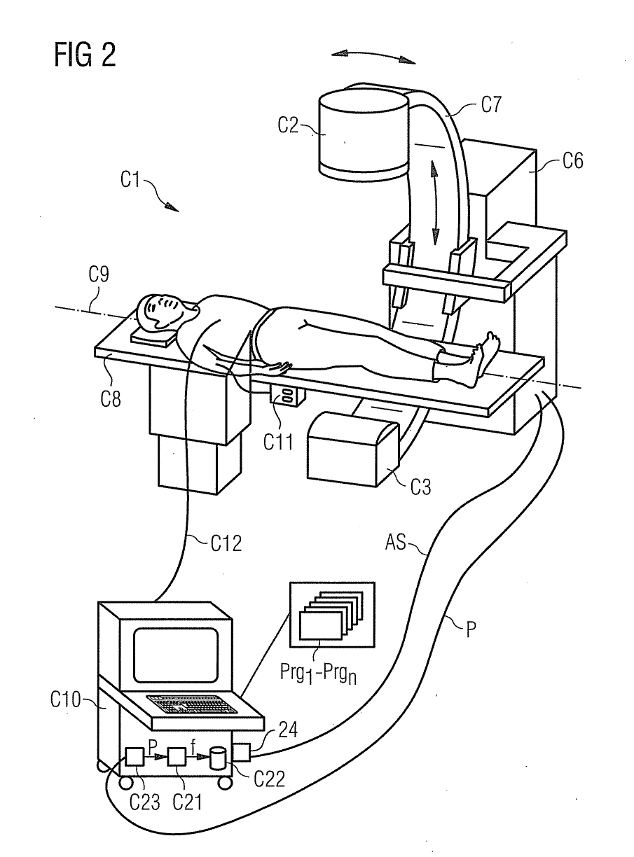

FIG. 2 shows a C-arm system in which, unlike the CT system in FIG. 1, the housing C6 supports the C-arm C7 on which are mounted on opposite sides the X-ray tube C2 and the detector C3. During scanning, the C-arm C7 is likewise pivoted about a system axis C9 so that scanning can take place from a large number of scanning angles and corresponding projection data p can be obtained from a large number of projection angles. Like the CT system in FIG. 1, the C-arm system C1 in FIG. 2 also has a control and computing unit C10 of the type described in connection with FIG. 1.

Embodiments of the invention are applicable to both systems shown in FIGS. 1 and 2. In addition, they can in principle also be used for other CT systems, e.g. for CT systems with a detector forming a complete ring. The CT systems in FIGS. 1 and 2 are merely examples of medical devices in which the invention can be used. Embodiments of the invention are not limited to computed tomography systems. For example, there are also other tomographic imaging methods whereby image data has to be generated from measured signals by means of image reconstruction calculations. One example of such tomographic imaging methods is NMR tomography or angiography. The system described below is also suitable for the latter.

There are special reconstruction computers for reconstructing tomographic images. Such a computer is shown in FIGS. 1 and 2 in the form of the control and computing unit C10 with its image reconstruction component C21. Because of the complexity of these calculations and the amount of scan data to be processed, very powerful computers are required for this purpose. These differ markedly from commercially available computers in respect of their size and price. Unlike commercially available computers they are very large and are therefore generally accommodated separately from the scanner in another room. Another reason for this separate arrangement is the noise pollution emanating from the computers' ventilation systems. Although these computers are expensive, they are not usually used to their full capacity, because very few medical devices are operated around the clock for scanning and image data reconstruction. If there are developments and improvements to the image reconstruction method, e.g. resulting in improved image quality or shorter computing times, the user of the medical imaging equipment cannot take advantage of this until the new software version has been installed. For upgrades, maintenance and fault repair, a service engineer has to come to the tomograph, which involves idle time and costs.

Instead of performing the image reconstruction calculations locally on a computer in the immediate vicinity of the scan data capture modality, i.e. the scanner, it is proposed to perform the calculations on a remote central computer or computer cluster. This approach is based on “cloud computing” principles whereby only a very slimmed-down client software is installed on a user's PC and the essential components of the program that require greater computing resources are run on a central server which is connected to the user's PC via a network, in particular the Internet, resulting in minimal hardware requirements for the user's PC. For private users, cloud computing solutions already exist which effectively offer the user a virtual computer, with all the applications running on the network and the user also being able to store all the data online on the server. The user can therefore access his virtual computer from any computer with Internet access, and all his files and applications are available to him.

Cloud computing is now being used for reconstructing medical image data. Unlike the solution for private users, the main advantage here is not the flexible access to data and programs from anywhere, but rather the possibility of very effectively utilizing the computer hardware for a large number of medical scanning systems and therefore of providing each medical device with greater computing capacity. The basic concept is that in this context it is more effective to share computer hardware in a large central computer or computer cluster than for each tomography to access a single small local computer.

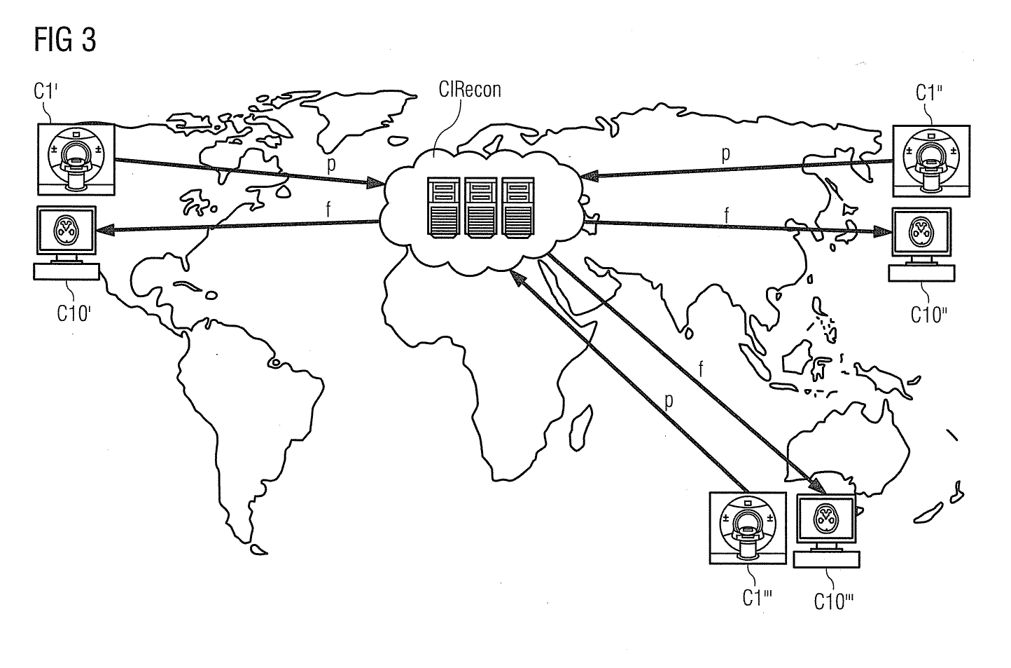

FIG. 3 shows such a system. Computed tomography systems C1′, C1″ and C1′″ are installed at various locations. Each of the computed tomography systems C1′, C1″ and C1′″ has a control and computing unit C10′, C10″ and C10′″. This is used in each case to control the scanning process and possibly initial processing of the captured scan data p. The scan data p is transmitted by the control and computing units C10′, C10″ and C10′″ to the central image reconstruction computer ClRecon where image reconstruction takes place, after which the resulting image datasets f are sent back to the control and computing units C10′, C10″ and C10′″. The latter can then display the reconstructed images and process them if required. In contrast to the control and computing unit C10 explained with reference to FIGS. 1 and 2, the control and computing units C10′, C10″ and C10′″ of the system illustrated in FIG. 3 therefore contain no image reconstruction components C21. The control and computing units C10′, C10″ and C10′″ can therefore be less powerful computers which bear no comparison to the large and expensive image reconstruction computers. The image reconstruction components are concentrated in the central image reconstruction computer ClRecon.

Efficient execution naturally requires a sufficiently fast network connection of the control and computing units C10′, C10″ and C10′″ to the central image reconstruction computer ClRecon in order to minimize the waiting times until the reconstructed image datasets f are received and in order to be no slower than in the conventional local, i.e. decentralized, reconstruction approach. In order to guarantee data security between the individual users C1′, C1″ and C1′″ and the central image reconstruction computer ClRecon, the data p and f is appropriately encrypted prior to transmission.

As an extension, not only the reconstruction of the medical image data f can be carried out on the central image reconstruction computer ClRecon but also the post-processing of the image data, which can be performed automatically, and computer aided diagnosis (CAD). Examples of this include removing bones from a CT image, automatic marking of blood vessel centerlines, etc.

Embodiments of such a centralized approach for performing medical image reconstruction confer many advantages:

a. As already mentioned, it is unnecessary for an image reconstruction component C21 to be present in the control and computing units C10, i.e. the scanner hardware required locally can be reduced, resulting in a cost saving. This could bring down the scanner basic price and achieve a lower entry level price for the fixed costs of a medical imaging system.
b. Through centralized image reconstruction, optimum utilization of the capacities of the reconstruction computers would be achieved around the clock. Instead of running a separate reconstruction computer on each device at less than full capacity, a central image reconstruction computer ClRecon which processes data from different systems, possibly from anywhere in the world, can be effectively used to capacity around the clock. This is particularly the case when the various scanners transmitting data to the central image reconstruction computer ClRecon are located in different time zones. The better capacity utilization of the computer hardware can help to reduce costs
c. A correspondingly powerful central image reconstruction computer ClRecon combined with sufficient transmission speed results in faster image reconstruction, thereby saving annoying and expensive waiting times.
d. Due to the elimination of local reconstruction computers, the space required for the imaging system can be significantly reduced, e.g. no additional space needs to be provided for the reconstruction computer, again resulting in a cost saving.
e. Centralized image reconstruction enables scanner providers to offer new charging models. Because of the elimination of reconstruction hardware, the fixed costs for the system user could be reduced. On the other hand, the completed reconstructions could be charged for, either individually (“pay per reconstruction”) through to “reconstruction flat rates”. For the customer, this would have the advantage that under-utilized scanners could be operated much more cost-effectively; for the provider, the advantages are stronger customer ties, as well as a continuous source of revenue.
f. Using the centralized image reconstruction approach also has the advantage that the manufacturer of a scanner can guarantee that the latest and best image reconstruction software is automatically always used, and possible image reconstruction errors due to suboptimal settings on the local reconstruction software are also avoided. The method can therefore also help to achieve better image quality.
g. The service facilities for the reconstruction hardware and software are also significantly improved. Because the reconstructions are only performed at a central point, the process can be optimally supported there by the competent specialists. The local service engineers would no longer have to attend to these problems, thereby reducing the downtimes of a scanner in the event of such problems. If there are bug-fixes and improvements to the reconstruction software, with a centralized method these can be made accessible simultaneously and much quicker to all users, because it does not require a large number of individual local installations.
h. A large central image reconstruction computer ClRecon provides a good basis for new, even more compute-intensive reconstruction techniques, e.g. for iterative image reconstruction, for which today's local image reconstruction computers often provide insufficient computing capacity.

It is accepted that any cost reduction in connection with obtaining images of a patient is highly desirable; for it means that the most advanced diagnostic possibilities can be available for more people.

The invention has been described above with reference to an example embodiment. It is self-evident that numerous variations and modifications are possible without departing from the scope of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A system for reconstructing image data of examination subjects from scan data, comprising:
at least a first and a second medical device to capture scan data of examination subjects; and
a computer to reconstruct image data from scan data, said computer being connected to the first and the second medical devices, wherein the computer includes an input to receive scan data from the medical devices and an output to transmit reconstructed image data to the first and second medical devices.

2. The system as claimed in claim 1, wherein the computer is connected to the first and second medical devices via the Internet.

3. The system as claimed in claim 1, wherein the first and the second medical devices are located in different time zones.

4. The system as claimed in claim 1, wherein the first and the second medical devices are different tomography devices.

5. The system as claimed in claim 4, wherein the first medical device is a CT scanner.

6. The system as claimed in claim 1, further comprising:
at least one encryption device for secure data transmission between the first and second medical devices and the computer.

7. A computer for reconstructing image data of examination subjects from scan data, comprising:
a connection to at least a first and a second medical device for capturing scan data of examination subjects;
an input to receive scan data from the first and second medical devices;
an image reconstruction component to reconstruct image data from received scan data; and
an output to transmit reconstructed image data to the first and second medical devices.

8. A method for reconstructing image data of examination subjects from scan data, the method comprising:
receiving, via a computer, first and second scan data, the first scan data of a first examination subject having previously been captured by a first medical device and the second scan data of a second examination subject having been captured by a second medical device;
reconstructing, via the computer, first image data of the first examination subject from the first scan data and second image data of the second examination subject from the second scan data; and
transmitting, via the computer, the first image data to the first medical device and the second image data to the second medical device.

9. A computer program including program code segments for carrying out the method as claimed in claim 8 when the computer program is run on the computer.

10. A computer program product comprising program code segments of a computer program which are stored on a computer-readable data medium, in order to carry out the method as claimed in claim 8 when the computer program is run on the computer.

11. The system as claimed in claim 2, wherein the first and the second medical devices are located in different time zones.

12. The system as claimed in claim 2, wherein the first and the second medical devices are different tomography devices.

13. The system as claimed in claim 12, wherein the first medical device is a CT scanner.

14. A computer readable medium including program segments for, when executed on a computer device, causing the computer device to implement the method of claim 8.
